(19) United States
(12) Patent Application Publication
(10) Pub. No.: US 2014/0015765 A1
(43) Pub. Date: Jan. 16, 2014

(54) Method for integrating flexible touch-screen module into display device

(71) Applicants: TING-CHING KUO, Chung Li City (TW); Jyr-Dwo Lee, Chung Li City (TW); Shih-Liang Chou, Chung Li City (TW); Hsueh Chih Chiang, Chung Li City (TW)

(72) Inventors: TING-CHING KUO, Chung Li City (TW); Jyr-Dwo Lee, Chung Li City (TW); Shih-Liang Chou, Chung Li City (TW); Hsueh Chih Chiang, Chung Li City (TW)

(21) Appl. No.: 13/549,423

(22) Filed: Jul. 14, 2012

(51) Int. Cl. G06F 3/041

(52) U.S. Cl. 345/173

(57) ABSTRACT

The invention relates to a simplified method for directly integrating a flexible touch-screen module into a display device. The method comprises adhering one surface of the flexible touch-screen module to one of an upper component and a lower component of the display device and then adhering the other surface of the flexible touch-screen module, opposite to the one surface of the flexible touch-screen module, to the other one of the upper component and the lower component of the display device, thereby obtaining a finished display device integrated with the flexible touch-screen module.

### BACKGROUND OF THE INVENTION

1. Field of the Invention

The present invention relates to a method for integrating a flexible touch-screen module into a display device and, more particularly, to a simplified method for directly integrating a flexible touch-screen module into a display device.

2. Description of the Prior Art

With the trend of humanized and simplified operation designing in human-machine interfaces, display devices provided with touch screens, especially liquid crystal display (LCD) devices provided with touch screens, have been rapidly invading into our personal and professional lives. A touch-screen LCD device enables a user to easily and conveniently input data by touching a finger or a pen-like article to the screen, rather than by relying upon an input device, such as a keyboard, a computer mouse or a remote control.

Nowadays, four main types of touch-screen technology are in use: resistive, capacitive, acoustic-wave and infrared. A touch screen is usually configured into the form of a rectangular-shaped transparent panel laminated onto the display side of a LCD device. The touch function is then realized by connecting the touch screen to the LCD device and a controller device via a flexible printed circuit board.

However, the fabrication of the laminated structure described above is complicated and cost-ineffective, as the touch-screen panel and the LCD device have to be produced separately and subsequently laminated together.

### SUMMARY OF THE INVENTION

An object of the invention is to provide a simplified method for directly integrating a flexible touch-screen module into a display device.

In order to achieve the object described above, the method according to the invention comprises adhering one surface of the flexible touch-screen module to one of an upper component or a lower component of the display device and then adhering the other surface of the flexible touch-screen module, opposite to the one surface of the flexible touch-screen module, to the other one of the lower component or the upper component of the display device, thereby obtaining a finished display device integrated with the flexible touch-screen module.

In some preferred embodiments, the flexible touch-screen module is integrated to the display device by adhering a lower surface of the flexible touch-screen module to a lower component of the display device and then adhering an upper surface of the flexible touch-screen module to an upper component of the display device. In other preferred embodiments, the flexible touch-screen module is integrated to the display device by adhering an upper surface of the flexible touch-screen module to an upper component of the display device and then adhering a lower surface of the flexible touch-screen module to a lower component of the display device.

In one embodiment, the upper component of the display device as described above is an upper polarizer and the lower component of the display device comprises, from top to bottom, an upper substrate, a color filter layer, a liquid crystal layer, a liquid crystal driving electrode layer, a lower substrate, a lower polarizer and a backlight module.

In one embodiment, the upper component of the display device as described above is a first phase difference plate and the lower component of the display device comprises, from top to bottom, an upper substrate, a color filter layer, a liquid crystal layer, a liquid crystal driving electrode layer, a lower substrate, a second phase difference plate and a backlight module.

In one embodiment, the upper component of the display device as described above is an upper polarizer and the lower component of the display device comprises, from top to bottom, an upper substrate, a transparent anode layer, a hole transport layer, an organic light-emitting layer, an electron transport layer, a cathode layer and a lower substrate.

In one embodiment, the display device described above is a passive matrix organic light emitting display (PMOLED) device, in which the transparent anode layer comprises a plurality of elongated anode stripes spaced apart from each other and extending in a first direction, and the cathode layer comprises a plurality of elongated cathode stripes spaced apart from each other and extending in a second direction substantially perpendicular to the first direction.

In one embodiment, the display device described above is an active matrix organic light emitting display (AMOLED) device, comprising a transparent anode layer provided with multiple pixel electrode zones and a thin film transistor (TFT) mounted atop of the transparent anode layer.

In one embodiment, the flexible touch-screen module described above includes a flexible transparent film provided with a transparent patterned conductive layer on at least one surface thereof.

In a preferred embodiment, the flexible transparent film is provided with transparent patterned conductive layers on both of the upper and lower surfaces thereof.

In a preferred embodiment, the transparent patterned conductive layer described above is fabricated by coating a layer of transparent conductive material on a surface of the flexible transparent film using a dry process and then patterning the coated transparent conductive layer.

In a preferred embodiment, the flexible touch-screen module described above has a thickness of less than 0.5 mm.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating a touch-screen structure fabricated by the method according to the invention;

FIG. 2 is a schematic diagram illustrating another touch-screen structure fabricated by the method according to the invention;

FIG. 3 is an exploded view of the touch-screen structure according to the first embodiment of the invention;

FIG. 4 is a schematic diagram illustrating the touch-screen structure according to the second embodiment of the invention;

FIG. 5 is an exploded view of the touch-screen structure according to the third embodiment of the invention; and

FIG. 6 is an exploded view of the touch-screen structure according to the fourth embodiment of the invention.

### DETAILED DESCRIPTION OF THE PREFERRED EMBODIMENTS

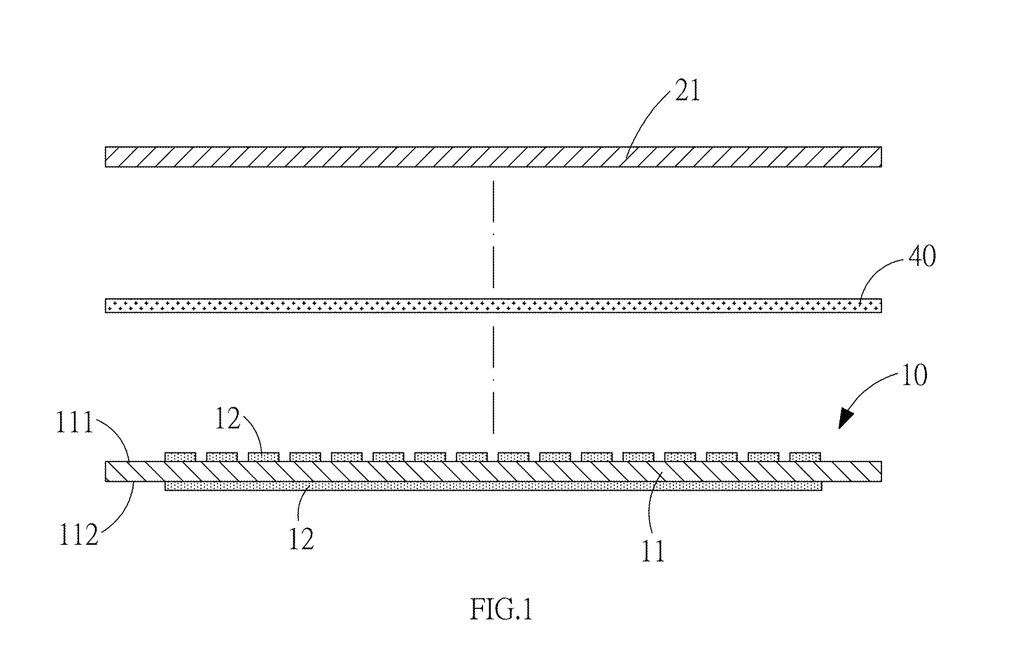

FIG. 1 is a schematic diagram illustrating a touch-screen structure fabricated by the method according to the invention. The invented method involves providing a flexible touch-screen module 10, which comprises a flexible transparent film 11 made of, for example, polyethylene terephthalate (PET). At least one surface of the flexible transparent film 11 is provided with a transparent patterned conductive layer 12. According to the embodiment illustrated in FIG. 1, the flexible transparent film 11 has an upper surface 111 and a lower surface 112, each being coated with a transparent patterned conductive layer 12. The flexible touch-screen module 10 described herein may by way of example be a digital capacitive touch panel with an overall thickness of less than 0.5 m. More specifically, the transparent patterned conductive layer formed on the upper surface 111 comprises a plurality of first striped electrode patterns arranged in parallel with one another (not shown). Further, the transparent patterned conductive layer formed on the lower surface 112 comprises a plurality of second striped electrode patterns arranged in parallel with one another and extending in a direction substantially perpendicular to a direction in which the first striped electrode patterns extend. The transparent patterned conductive layer 12 is fabricated by coating a layer of transparent conductive material on the upper surface and/or the lower surface of the flexible transparent film 11 using a dry process, such as vacuum evaporation, sputtering and ion plating, and then patterning the coated transparent conductive layer using, for example, photolithography.

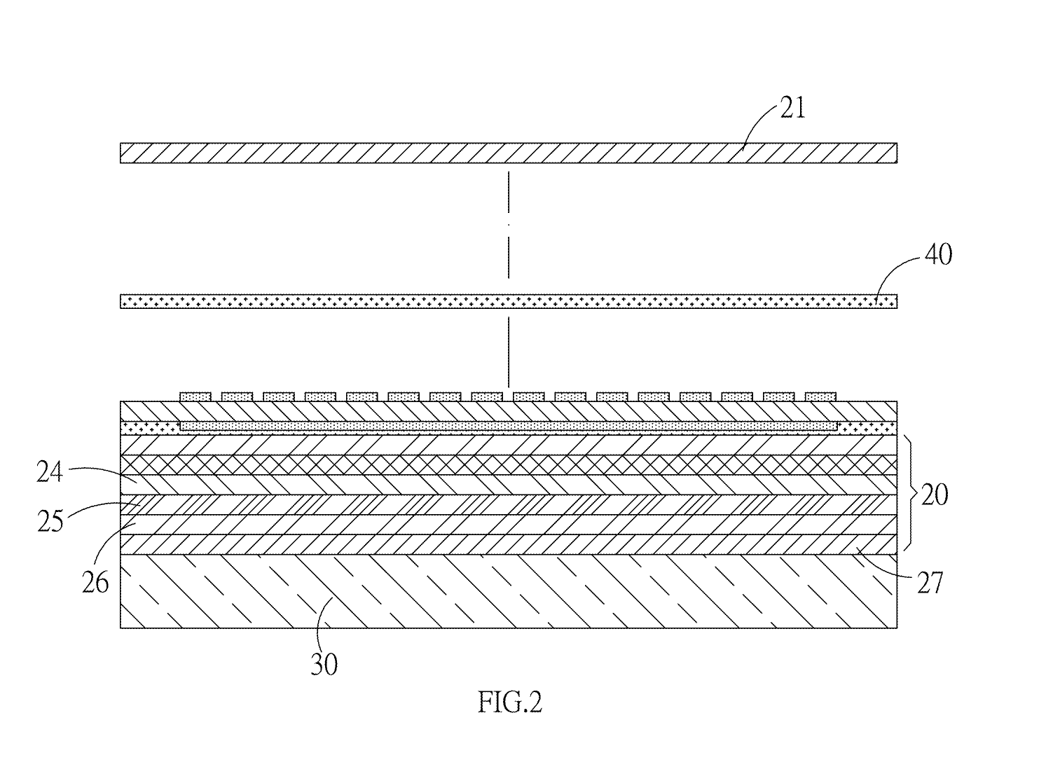

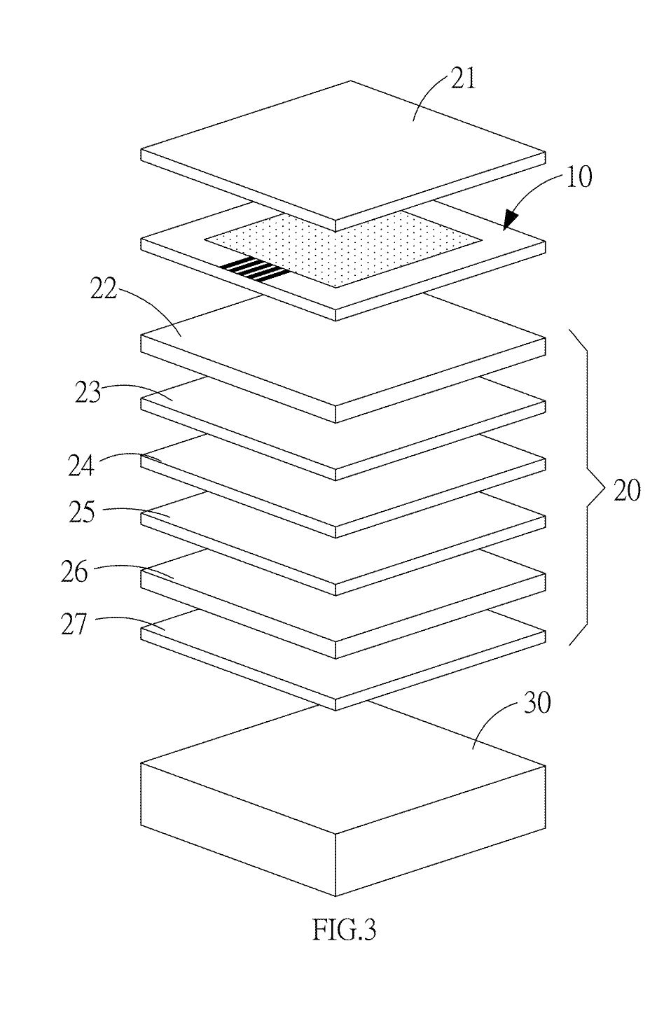

The method disclosed herein comprises a step of adhering a lower surface of the flexible touch-screen module 10 to a lower component of the display device, in which the display device comprises a LCD module 20 and a backlight module 30. Now referring to FIGS. 2 and 3, the lower surface of the flexible touch-screen module 10 is adhered to the lower component of the display device, wherein the LCD module 20 serves as the lower component comprising, from top to bottom, an upper substrate 22, a color filter layer 23, a liquid crystal layer 24, a liquid crystal driving electrode layer 25, a lower substrate 26 and a lower polarizer 27. According to the embodiment illustrated in FIGS. 2 and 3, the flexible touch-screen module 10 is adhered to the upper surface of the upper substrate 22 using an optical clear adhesive 40.

Next, the upper surface of the flexible touch-screen module 10 is adhered to an upper polarizer 21 of the display device using, for example, the optical clear adhesive 40, thereby obtaining a finished display device integrated with the flexible touch-screen module 10.

It is apparent to those skilled in the art that the upper component of the display device may be a first phase difference plate instead of the upper polarizer described above. In this case, the lower component of the display device comprises, from top to bottom, an upper substrate, a color filter layer, a liquid crystal layer, a liquid crystal driving electrode layer, a lower substrate, a second phase difference plate and a backlight module.

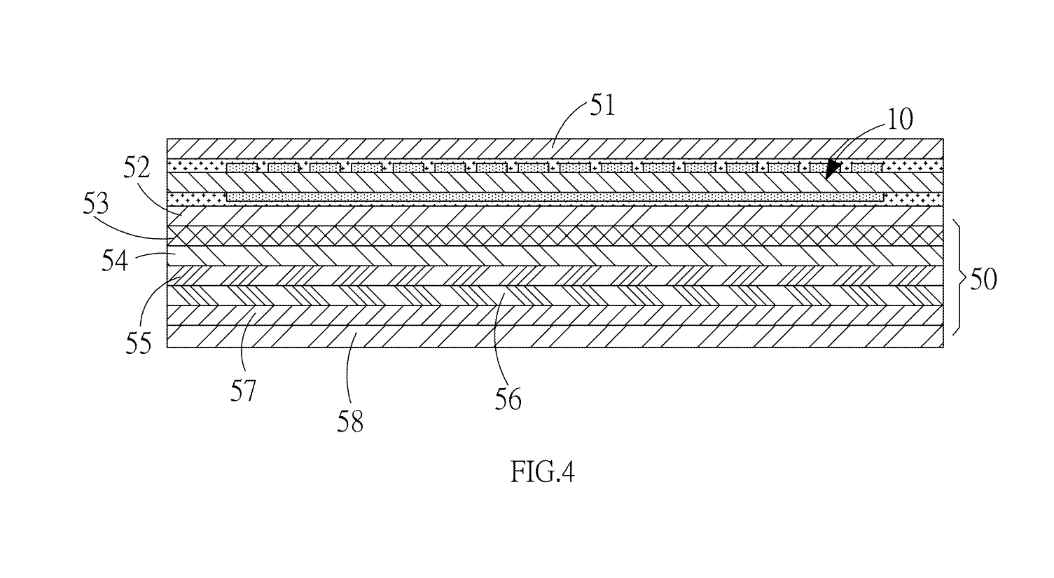

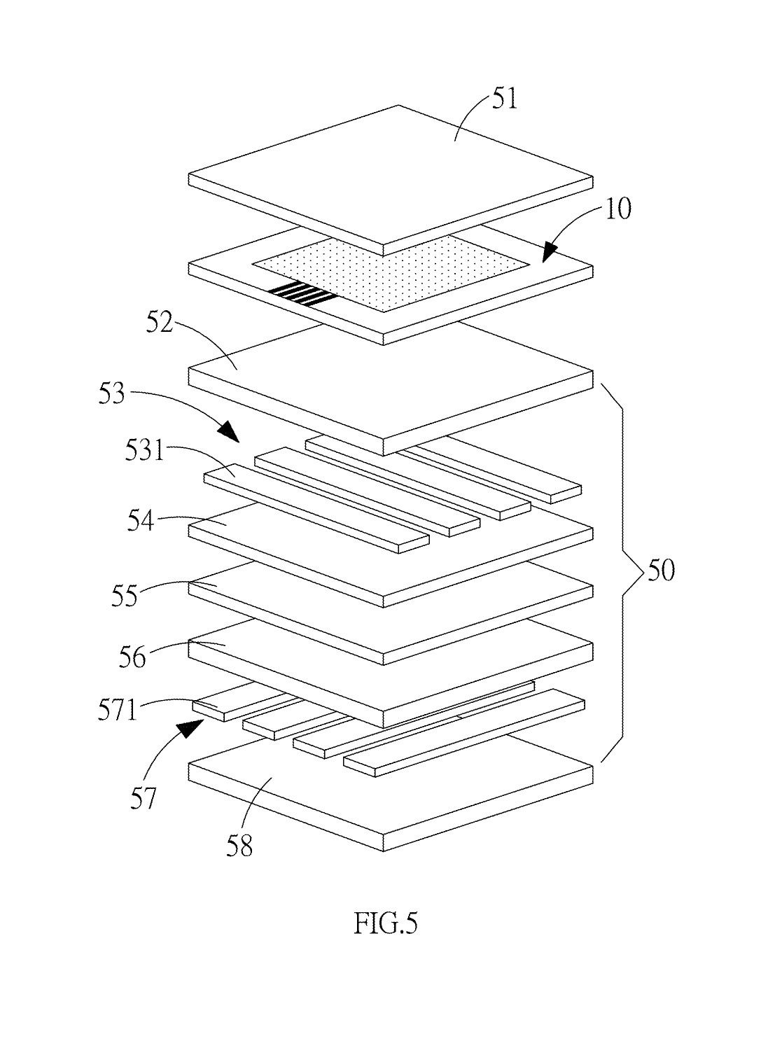

Optionally, the display device described herein may be an organic light emitting display (OLED) device 50. As shown in FIG. 4, the OLED device 50 has a lower component comprising, from top to bottom, an upper substrate 52, a transparent anode layer 53, a hole transport layer 54, an organic light-emitting layer 55, an electron transport layer 56, a cathode layer 57 and a lower substrate 58. The lower surface of the flexible touch-screen module 10 is adhered to the upper substrate 52 of the OLED device, and then the upper surface of the flexible touch-screen module 10 is adhered to an upper polarizer 51 of the OLED device. As shown in FIG. 5, the transparent anode layer 53 comprises a plurality of elongated anode stripes 531 spaced apart from each other and extending in a first direction, whereas the cathode layer 57 comprises a plurality of elongated cathode stripes 571 spaced apart from each other and extending in a second direction substantially perpendicular to the first direction. The arrangement described above constitutes a passive matrix organic light emitting display (PMOLED) device, in which the elongated anode stripes 531 intersect with the elongated cathode stripes 571 to define pixels at intersections. The pixels will emit and generate light when the elongated anode stripes 531 and the elongated cathode stripes 571 are activated. The PMOLED device is advantageous in easy fabrication.

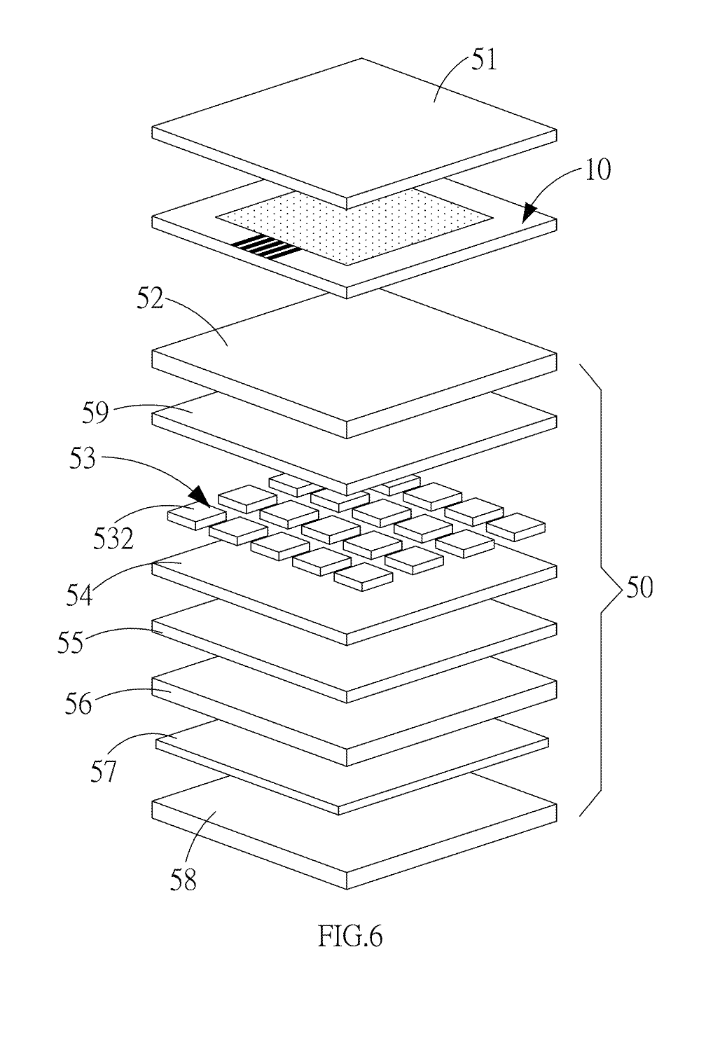

FIG. 6 shows an active matrix organic light emitting display (AMOLED) device. The device comprises a transparent anode layer 53 provided with an array of pixel electrode zones 532 and a thin film transistor (TFT) 59 mounted atop of the transparent anode layer 53 for controlling the charging of a storage capacitor, so as to provide controlled brightness grayscale characters of the OLED device. The AMOLED device is advantageous in having fast response time and very useful in improving the quality of images displayed.

It should be noted that the invention further contemplates the embodiments where the upper surface of the flexible touch-screen module is adhered to the upper component of the display device and then the lower surface of the flexible touch-screen module is adhered to the lower component of the display device, so as to obtain a finished display device integrated with the flexible touch-screen module.

It should be further noted that the method disclosed herein integrates a flexible touch-screen module directly with a display device by virtue of adhering a flexible touch-screen module to an upper component (such as a polarizer or a phase difference plate) or a lower component of a display device and then adhering the flexible touch-screen module to the other component of the display device. Therefore, the invented method is considerably simplified as compared to the traditional methods.

In conclusion, the method disclosed herein can surely achieve the intended objects and effects of the invention by virtue of the processing steps described above. While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A method for integrating a flexible touch-screen module into a display device, comprising the steps of:
adhering one surface of the flexible touch-screen module to a lower component of the display device; and
adhering the other surface of the flexible touch-screen module, opposite to the one surface of the flexible touch-screen module, to an upper component of the display device, thereby obtaining a finished display device integrated with the flexible touch-screen module.

2. The method for integrating a flexible touch-screen module into a display device according to claim 1, wherein the upper component of the display device is an upper polarizer and the lower component of the display device comprises, from top to bottom, an upper substrate, a color filter layer, a liquid crystal layer, a liquid crystal driving electrode layer, a lower substrate, a lower polarizer and a backlight module.

3. The method for integrating a flexible touch-screen module into a display device according to claim 1, wherein the upper component of the display device is a first phase difference plate and the lower component of the display device comprises, from top to bottom, an upper substrate, a color filter layer, a liquid crystal layer, a liquid crystal driving electrode layer, a lower substrate, a second phase difference plate and a backlight module.

4. The method for integrating a flexible touch-screen module into a display device according to claim 1, wherein the upper component of the display device is an upper polarizer and the lower component of the display device comprises, from top to bottom, an upper substrate, a transparent anode layer, a hole transport layer, an organic light-emitting layer, an electron transport layer, a cathode layer and a lower substrate.

5. The method for integrating a flexible touch-screen module into a display device according to claim 4, wherein the display device is a passive matrix organic light emitting display (PMOLED) device, in which the transparent anode layer comprises a plurality of elongated anode stripes spaced apart from each other and extending in a first direction and the cathode layer comprises a plurality of elongated cathode stripes spaced apart from each other and extending in a second direction substantially perpendicular to the first direction.

6. The method for integrating a flexible touch-screen module into a display device according to claim 4, wherein the display device is an active matrix organic light emitting display (AMOLED) device, in which the transparent anode layer is provided with multiple pixel electrode zones and a thin film transistor (TFT) is mounted atop of the transparent anode layer.

7. The method for integrating a flexible touch-screen module into a display device according to claim 1, wherein the flexible touch-screen module comprises a flexible transparent film provided with a transparent patterned conductive layer on at least one surface thereof.

8. The method for integrating a flexible touch-screen module into a display device according to claim 7, wherein the flexible transparent film is provided with transparent patterned conductive layers on both of upper and lower surfaces thereof.

9. The method for integrating a flexible touch-screen module into a display device according to claim 7, wherein the transparent patterned conductive layer is fabricated by coating a layer of transparent conductive material on a surface of the flexible transparent film using a dry process and then patterning the coated transparent conductive layer.

10. The method for integrating a flexible touch-screen module into a display device according to claim 7, wherein the flexible touch-screen module has a thickness of less than 0.5 mm.

11. A method for integrating a flexible touch-screen module into a display device, comprising the steps of:
adhering one surface of the flexible touch-screen module to an upper component of the display device; and
adhering the other surface of the flexible touch-screen module, opposite to the one surface of the flexible touch-screen module, to a lower component of the display device, thereby obtaining a finished display device integrated with the flexible touch-screen module.

12. The method for integrating a flexible touch-screen module into a display device according to claim 11, wherein the upper component of the display device is an upper polarizer and the lower component of the display device comprises, from top to bottom, an upper substrate, a color filter layer, a liquid crystal layer, a liquid crystal driving electrode layer, a lower substrate, a lower polarizer and a backlight module.

13. The method for integrating a flexible touch-screen module into a display device according to claim 11, wherein the upper component of the display device is a first phase difference plate and the lower component of the display device comprises, from top to bottom, an upper substrate, a color filter layer, a liquid crystal layer, a liquid crystal driving electrode layer, a lower substrate, a second phase difference plate and a backlight module.

14. The method for integrating a flexible touch-screen module into a display device according to claim 11, wherein the upper component of the display device is an upper polarizer and the lower component of the display device comprises, from top to bottom, an upper substrate, a transparent anode layer, a hole transport layer, an organic light-emitting layer, an electron transport layer, a cathode layer and a lower substrate.

15. The method for integrating a flexible touch-screen module into a display device according to claim 14, wherein the display device is a passive matrix organic light emitting display (PMOLED) device, in which the transparent anode layer comprises a plurality of elongated anode stripes spaced apart from each other and extending in a first direction and the cathode layer comprises a plurality of elongated cathode stripes spaced apart from each other and extending in a second direction substantially perpendicular to the first direction.

16. The method for integrating a flexible touch-screen module into a display device according to claim 14, wherein the display device is an active matrix organic light emitting display (AMOLED) device, in which the transparent anode layer is provided with multiple pixel electrode zones and a thin film transistor (TFT) is mounted atop of the transparent anode layer.

17. The method for integrating a flexible touch-screen module into a display device according to claim 11, wherein the flexible touch-screen module comprises a flexible transparent film provided with a transparent patterned conductive layer on at least one surface thereof.

18. The method for integrating a flexible touch-screen module into a display device according to claim 17, wherein the flexible transparent film is provided with transparent patterned conductive layers on both of upper and lower surfaces thereof.

19. The method for integrating a flexible touch-screen module into a display device according to claim 17, wherein the transparent patterned conductive layer is fabricated by coating a layer of transparent conductive material on a surface of the flexible transparent film using a dry process and then patterning the coated transparent conductive layer.

20. The method for integrating a flexible touch-screen module into a display device according to claim 17, wherein the flexible touch-screen module has a thickness of less than 0.5 mm.
